(19) United States
(12) Patent Application Publication
(10) Pub. No.: US 2010/0102918 A1
(43) Pub. Date: Apr. 29, 2010

(54) ELECTROMECHANICAL SWITHCING DEVICE FOR PROTECTING ELECTRICAL WIRES AND/OR CONSUMERS AND USE OF A THERMAL COUPLING IN AN ELECTROMECHANICAL SWITCHING DEVICE

(75) Inventors: Werner Decker, Amberg (DE); Martin Heimler, Fensterbach (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, Munich (DE)

(21) Appl. No.: 12/449,307

(22) PCT Filed: Jan. 31, 2008
(86) PCT No.: PCT/EP2008/051200

§ 371 Date: Jul. 31, 2009

(30) Foreign Application Priority Data
Feb. 1, 2007 (DE) 10 2007 005 135.4

(51) Int. Cl. H01H 71/14

(52) U.S. Cl. 337/14

(57) ABSTRACT

An electromechanical switching device is disclosed for protecting electrical wires and/or consumers. In at least one embodiment, the device includes at least one thermal triggering element and at least one switching device-internal heat source. For the at least one thermal triggering element, the electromechanical switching device includes a thermal coupling of at least one of the switching device-internal heat sources. At least one embodiment of the invention also relates to the use of a thermal coupling.

### PRIORITY STATEMENT

This application is the national phase under 35 U.S.C. §371 of PCT International Application No. PCT/EP2008/051200 which has an International filing date of Jan. 31, 2008, which designated the United States of America, and which claims priority on German patent application number DE 10 2007 005 135.4 filed Feb. 1, 2007, the entire contents of each of which are hereby incorporated herein by reference.

### BACKGROUND

Electromechanical switching devices are used for protecting electrical wires and/or consumers. If a fault occurs in the form of an overload, wires and consumers are heated up significantly by the current flowing into the electrical wires. To prevent fires as well as damage to consumers and wires resulting therefrom, it is necessary in many applications to use electromechanical switching devices which offer protection against overload. A thermal triggering element is often used for this purpose, the triggering element offering a proven possibility of creating protection against overload.

In electromechanical switching devices comprising at least one thermal triggering element, there is a trigger characteristic curve which describes the causing limit current which brings about the triggering.

The ambient temperature has a great influence on the trigger characteristic curve due to the functionality of the thermal triggering element. A compensation strip thus actively reacts to the ambient temperature. The compensation strip is intended to assume the temperature of the surroundings and to influence the trigger behavior by way of temperature compensation. The aim is for the limit current to remain stable in the case of different ambient temperatures.

The limit current is to remain as constant and stable as possible during the service life of the switching device. Disturbance variables, like different connection types or the impairment of the contact, change the thermal conditions in the switching device. They therefore also influence the limit current stability.

The influences disturbing the limit current stability of the thermal triggering element were previously minimized during the development of electromechanical switching devices by the contacts and connections being removed from the thermal triggering elements if possible. If the electromechanical switching devices are to be configured smaller in terms of their physical size, it is accordingly more difficult to create the necessary distance.

### SUMMARY

At least one embodiment of the invention enables the development of a smaller electromechanical switching device for protecting electrical wires or consumers, which still exhibits adequate limit current stability.

At least one embodiment is directed to an electromechanical switching device comprising at least one thermal triggering element and at least one switching device-internal heat source, namely if the electromechanical switching device comprises a thermal coupling of at least one of the switching device-internal heat sources for the at least one thermal triggering element. The thermal image of the disturbance variable is actively transmitted to the thermal triggering element, which can react to the disturbance variable in order to influence the triggering element behavior of the thermal triggering element. This contributes to the stabilization of the limit current behavior, It also offers the possibility of additional cooling, e.g. of the contact region, since heat is transported out of the heat source by means of the thermal coupling. The power density can thus be increased.

At least one embodiment of the invention can also be achieved by using a thermal coupling in an electromechanical switching device for protecting electrical wires or consumers, for preventing disturbance variables in the electromechanical switching device.

It is particularly advantageous if the thermal coupling of the disturbance variables is attached between a compensation strip of the thermal triggering element. This allows a particularly compact design of the electromechanical switching device, since it does not require any additional compensation strips for the same phase or possibly also phases. If the compensation strip is embodied so as to assume the temperature of the ambient of the electromechanical switching device and to influence the triggering element behavior, caused by one or several disturbance variables, by at least one of the thermal triggering elements, the same compensation strip can at the same time also immediately compensate for the effect of the ambient temperature and the disturbance variable or variables.

If the electromechanical switching device is a multiphase switching device for three-phase current applications and the thermal coupling connects switching device-internal heat sources of at least two of the three phases, a switching device may possibly be constructed with only one thermal compensation strip. When using a compensation strip for e.g. the disturbance variables contact, all three phases can be thermally connected. A thermal compensation of the disturbance variables thus results between the three phases, which can allow for a simplified structure. This compensation strip is then used to compensate for both the ambient temperature as well as for the increase in the disturbance variable resistance of the contacts in all three phases.

The thermal coupling can favorably consist of at least one heat-conductive polymer, copolymer, ceramics and/or an electrically-insulating effectively heat-conductive material.

### BRIEF DESCRIPTION OF THE DRAWINGS

An embodiment of the invention is described in more detail below with reference to the drawing shown in the FIGURE.

FIG. 1 is directed to an embodiment of the invention.

### DETAILED DESCRIPTION OF THE EXAMPLE EMBODIMENTS

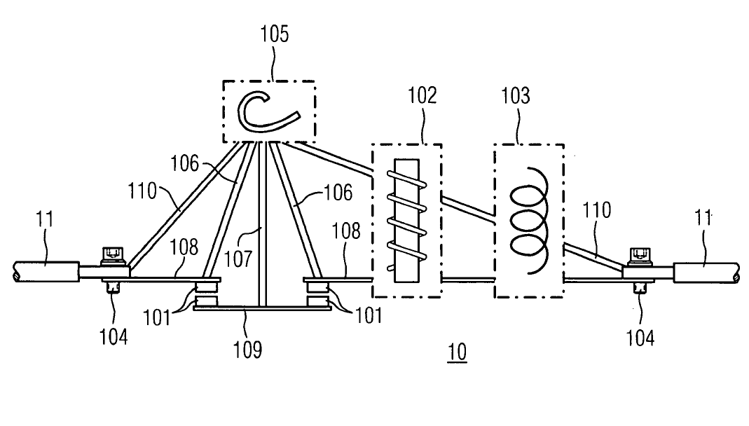

As shown in FIG. 1, one phase of an electromechanical switching device 10 is connected to two electrical wires 11, e.g. cables. Two or three phases are essentially needed for three phase current applications. To this end, the switching device 10 has two or more connections 104, which are embodied in FIG. 1 as screw terminals.

The connections 104 are connected in each instance to fixed switching elements 108. By moving one or several of the moveable switching elements 109, the phase is switched. If the moveable switching element 109 is moved, the contacts 101 of the moveable switching element 109 are moved towards or away from the contacts 101 of the fixed switching elements 104, 108.

If the contacts 101 of the moveable switching element 109 touch the contacts 101 of the fixed switching element 108, the connections 104 are connected on both sides and the electromechanical switching device 10 has connected the phase.

If the contacts 101 of the moveable switching element 109 are removed from the contacts 101 of the fixed switching elements 108, the electromechanical switching device 10 has separated the phase.

A disturbance variable has an additional heat source. The term heat source is used below for a heat source resulting from one or several disturbance variables.

As a possible further heat source, a cable 11 in the connection 104 can be fastened with excessively small locking torque. It is also possible for dirt, grease or corrosion to be present on the end of the cable 11, thereby preventing an effective conductive contact between the cable 11 and the fixed switching element 108. This may result in a greater power loss in the connection area than occurs when in new condition and in the case of properly made connections.

The contacts 101 can also change their functionality as a result of contact wear or contamination such that there is a loss of heat, in other words a significant increase in the power loss in the contact area than in the new state. The connections 104 can thus function as device-internal heat sources.

The temperature of the moveable switching element 109, of the fixed switching element 108 or of the connection 104 can be transported to the compensation strip 105 by means of heat transfer using one or several thermal couplings 106, 107, 110. The compensation strip 105, which maps the heat image of the disturbance variables contact or connection, can actively react to the disturbance variable for instance in order to influence the trigger behavior of the thermal triggering element 102. To this end, in the thermal triggering element 102, the thermal coupling can be embodied as a so-called compensation strip in bimetal form. The compensation strips should then react to the respective interference source.

Inventive features of an embodiment may then have an active influence on the disturbance variables as a result of thermally coupling the disturbance variables to the compensation strips 10.

The electromechanical switching device 10 may be a circuit breaker, a limiter or a compact branch. It is however also possible for the electromechanical switching device 10 to be a device which only includes a circuit breaker or a limiter or a compact branch.

An additional customer benefit is that the trigger point and/or limit current of the switching device 10 does not have to be readjusted following e.g. a short circuit or other influences on the transmission resistance of the contact 101 or connections 104. A readjustment of the trigger point can also be prevented.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An electromechanical switching device for protecting at least one of electrical wires and consumers, comprising:
at least one thermal triggering element; and
at least one switching device-internal heat source,
the electromechanical switching device for the at least one thermal triggering element including a thermal coupling of at least one of the switching device-internal heat sources.

2. The electromechanical switching device as claimed in claim 1, wherein the thermal coupling is attached between a compensation strip of the thermal triggering element.

3. The electromechanical switching device as claimed in claim 2, wherein the compensation strip is embodied so as to assume the temperature of the surroundings of the electromechanical switching device and to influence the trigger behavior of at least one of the thermal triggering elements.

4. The electromechanical switching device as claimed in claim 1, wherein the thermal coupling thermally connects at least two of the switching device-internal heat sources.

5. The electromechanical switching device as claimed in claim 1, wherein the electromechanical switching device is a multiphase switching device for three phase current applications and the thermal coupling thermally coupling switching device-internal heat sources from at least two of the phases.

6. The electromechanical switching device as claimed in claim 1, wherein the thermal coupling consists of at least one of at least one heat-conductive polymer, at least one copolymer, at least one ceramic metal and at least one electrically insulating effectively heat-conductive material.

7. The electromechanical switching device as claimed in claim 1, wherein the at least one switching device-internal heat source includes at least one of at least one connection for at least one electrical conductor, at least one fixed switching piece, at least one moveable switching piece and at least one contact.

8. The electromechanical switching device as claimed in claim 1, wherein the electromechanical switching device is or includes a circuit breaker, a limiter or a compact branch.

9. A method, comprising:
using a thermal coupling, in an electromechanical switching device for protecting at least one of electrical wires and consumers, for preventing disturbance variables in the electromechanical switching device, thermal coupling of at least one switching device-internal heat source to a thermal triggering element, embodied to assume a temperature of the surroundings of the electromechanical switching device and to influence the triggering element behavior of the thermal triggering element, being arranged.

10. The electromechanical switching device as claimed in claim 1, wherein the thermal coupling includes at least one of at least one heat-conductive polymer, at least one copolymer, at least one ceramic metal and at least one electrically insulating effectively heat-conductive material.

11. The electromechanical switching device as claimed in claim 1, wherein the electromechanical switching device is or includes at least one of a circuit breaker, a limiter and a compact branch.
